(19) United States
(12) Patent Application Publication
(10) Pub. No.: US 2026/0148123 A1
(43) Pub. Date: May 28, 2026

(54) GENERATING DIVERSE TRAINING DATA FOR TRAINING MUSIC-TEXT EMBEDDING MODELS

(71) Applicant: Adobe Inc., San Jose, CA (US)

(72) Inventors: Justin SALAMON, San Francisco, CA (US); Oriol NIETO-CABALLERO, Oakland, CA (US); Nicholas J. BRYAN, Belmont, CA (US); Ilaria MANCO, London (GB)

(73) Assignee: Adobe Inc., San Jose, CA (US)

(21) Appl. No.: 18/958,454

(22) Filed: Nov. 25, 2024

(51) Int. Cl. G06N 20/00

(52) U.S. Cl. CPC G06N 20/00

(57) ABSTRACT

Embodiments are disclosed for generating a diverse training dataset for training encoders to map music and natural language text to a joint embedding space. The method may include obtaining a training audio sequence and descriptive tags associated with the training audio sequence. The disclosed systems and methods further comprise generating a plurality of different subsets of the descriptive tags. The disclosed systems and methods further comprise generating, by a large language model, a plurality of training captions describing the training audio sequence, where each training caption is generated using one of the plurality of different subsets of the descriptive tags. The disclosed systems and methods further comprise generating a plurality of negative training captions for the training audio sequence by modifying elements of the plurality of training captions. The plurality of training captions and the plurality of negative training captions can then be combined to create a training dataset.

### BACKGROUND

Creative projects, such as user-generated video content, often involve the pairing of music with the video content. However, choosing the appropriate music to pair with the video content can be a challenging and time-consuming task, as there are many components of music to consider, such as genre and mood. The challenges can be exacerbated when a music library is extensive.

### SUMMARY

Introduced here are techniques/technologies for generating diverse training data for music-text representation learning. Once generated, the diverse training data can be used to train a music-text encoding system to encode music and natural language text into a joint embedding space. Once trained, the music-text encoding system can be used for various applications, including music searching and/or music generation using natural language text inputs.

More specifically, in one or more embodiments, diverse training data is generated from an input that includes a training audio sequence and descriptive tags. The descriptive tags describe aspects of the training audio sequence using keywords in one or more categories, including genre, mood, and instrumentation. Multiple training captions are first generated by a large language model using different subsets of the descriptive tags, where each of the multiple training captions are based on different subsets of the same initial set of descriptive tags for the same training audio sequence. As the multiple training captions describe the same training audio sequence is different ways, they are complementary, but partial views of the training audio sequence. Using the multiple training captions, hard negative training captions, which are closely aligned to the training captions, can then be generated. Each hard negative training caption is a partially perturbed version of one of the training captions generated by the large language model, where one or more keywords are swapped with an alternative descriptor from the same category. For example, given a training caption that includes the genre “rock,” the hard negative training caption can swap “rock” for “pop.”

In one or more embodiments, after the training captions and hard negative training captions are generated, they can be aggregated into a diverse training set that can be used to train a music-text encoding system to map music audio and natural language text to a shared embedding space. Once trained, the music-text encoding system can be used to perform searches of a music library and/or to generate music given a natural language text description.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating diverse training data for an input training audio sequence using a machine learning model in accordance with one or more embodiments;

FIG. 2 illustrates exemplary training captions and negative training captions generated by a music-text encoding system in accordance with one or more embodiments;

FIG. 3 illustrates a diagram of a process of training a music-text encoding system to encode music audio and natural language text into a shared embedding space in accordance with one or more embodiments;

FIG. 4 illustrates a schematic diagram of a music-text encoding system in accordance with one or more embodiments;

FIG. 5 illustrates a table of experimental results of training models with the diverse training dataset in accordance with one or more embodiments;

FIG. 6 illustrates a flowchart of a series of acts in a method of generating a diverse training dataset for training a music-text encoding system in accordance with one or more embodiments;

FIG. 7 illustrates a flowchart of a series of acts in a method for training a music-text encoding system using a diverse training dataset in accordance with one or more embodiments;

FIG. 8 illustrates a flowchart of a series of acts in a method for performing a music search using a music-text encoding system trained using a diverse training dataset in accordance with one or more embodiments; and

FIG. 9 illustrates a block diagram of an exemplary computing device in accordance with one or more embodiments.

### DETAILED DESCRIPTION

One or more embodiments of the present disclosure include a method of generating diverse training data for music-text representation learning. The diverse training data, when used to train a music-text encoding system, produces a model that can be used for music searching and/or music generation. Some existing techniques involving multimodal audio-text encoders that are not trained for music. However, these techniques are focused on non-music audio and produce sub-optimal results for music-text learning when given text queries that specifically describe music. A significant limitation of these multimodal audio-text encoders is the scarcity of paired music-text data, especially data with natural language descriptions of the music required for training such models. For example, typical training datasets derive a single natural language text caption by using all of the descriptive tags describing audio.

To address these and other deficiencies in conventional systems, the music-text encoding system of the present disclosure generates diverse training data for training a music-text encoder model from a training input that includes descriptive tags for each training audio sequence. The diverse training data includes multiple natural language training captions generated from different subsets of the descriptive tags for each song/music track. The diverse training data is further supplemented by the generation of hard negative training captions that are created by swapping out one or more keywords or elements in training captions with inaccurate words.

The generation of diverse training by the music-text encoding system of the present disclosure produces models with improved music-text representation learning that addresses the limitations of the existing solutions. One advantage of the generation of multiple training captions using different subsets of descriptive tags of a song is that it addresses the fact that people can describe the same song in different ways (e.g., by focusing on different instruments used or what moods different parts of the song conveys, etc.). Further, as hard negative training captions are closely aligned with true or positive training captions, the music-text encoder model is encouraged to learn to match the positive training captions and reject the negative training captions. This helps force the music-text encoder model to closely consider all of the text in the captions, resulting in better music searching and music generation.

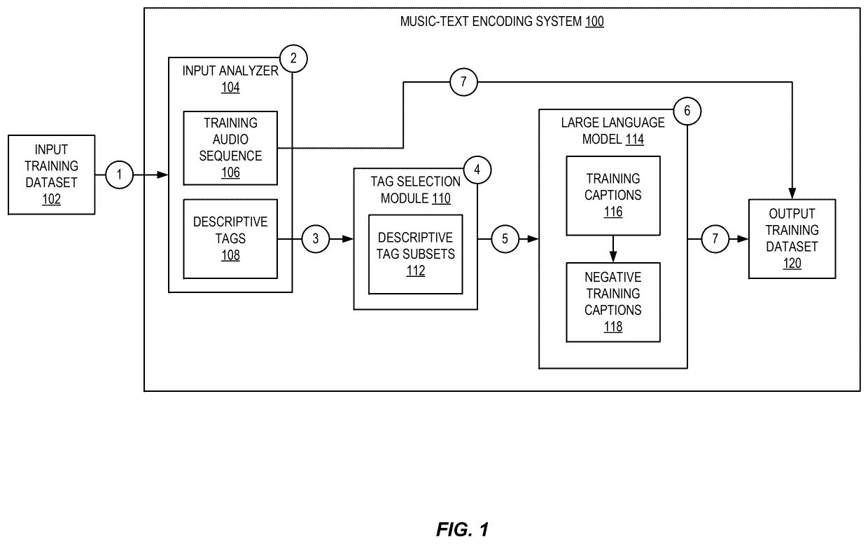

FIG. 1 illustrates a diagram of a process of generating diverse training data for an input training audio sequence using a machine learning model in accordance with one or more embodiments. In one or more embodiments, the diverse training data is generated by passing descriptive tags for a training audio sequence through an augmentation pipeline that generates a plurality of training captions and negative training captions. As shown in FIG. 1, a music-text encoding system 100 receives an input training dataset 102, as shown at numeral 1. For example, the music-text encoding system 100 receives the input training dataset 102 from a user via a computing device or from a memory or storage location. In one or more embodiments, the input training dataset 102 includes a training audio sequence 106 and descriptive tags 108. In one or more embodiments, the input training dataset 102 can be provided through the use of a graphical user interface (GUI). In one or more embodiments, the input training dataset 102 can be uploaded directly or the user can provide a URL to a location storing the input training dataset 102.

The music-text encoding system 100 includes an input analyzer 104 that receives the input training dataset 102. In some embodiments, the input analyzer 104 is configured to extract training audio sequence 106 and the descriptive tags 108 from the input training dataset 102, at numeral 2. Although the example of FIG. 1 illustrates a single training audio sequence 106, the input training dataset 102 can include a plurality of training audio sequences and their associated descriptive tags. The descriptive tags can describe various aspects of a corresponding training audio sequence in different categories, including, but not limited to, genre, mood, and instrumentation. In some embodiments, the descriptive tags 108 can be human-derived or human-written and provided to the music-text encoding system 100. In other embodiments, the descriptive tags 108 can be automatically generated from the training audio sequence 106 using a machine learning model trained on music tagging (e.g., by a machine learning model in the music-text encoding system 100 or a machine learning model external to the music-text encoding system 100). In other embodiments, the descriptive tags 108 can be a combination of human-derived and machine learning model-derived tags.

The input analyzer 104 then sends the descriptive tags 108 to tag selection module 110, as shown at numeral 3. In one or more embodiments, the tag selection module 110 generates a plurality of descriptive tag subsets 112 using the descriptive tags 108, at numeral 4. In one or more embodiments, the tag selection module 110 sub-samples the descriptive tags 108 to obtain a descriptive tag subset. This process can be referred to as augmented view dropout. The tag selection module 110 can repeat the process multiple times to obtain the plurality of descriptive tag subsets 112, where each includes a different subset of the descriptive tags 108.

In one or more embodiments, the plurality of descriptive tag subsets 112 generated by the tag selection module 110 are sent to a large language model 114, as shown at numeral 5. In one or more embodiments, the large language model 114 is a multimodal large language model, or a similar neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the large language model 114 generates training captions 116 and negative training captions 118 using the plurality of descriptive tag subsets 112 at numeral 6. In one or more embodiments, the large language model 114 is trained to convert each of the plurality of descriptive tag subsets 112 into a separate training caption describing the music audio in the training audio sequence 106. For example, each of the training captions 116 can be a natural language sentence using the descriptive tags in a corresponding descriptive tag subset. In one or more embodiments, the large language model 114 uses a prompt-analogies technique where the prompt includes a small number of example pairs, where each pair includes: (a) a set of descriptive tags and (b) a human-written caption describing the same music track as the descriptive tags. These “analogies,” or examples of inputs (e.g., tags) paired with desired outputs (e.g., captions), guide the large language model 114 in how to leverage going from descriptive tags to a caption.

In another embodiments, the large language model 114 can generate captions using a different technique when not given descriptive tags. In one or more embodiments, in the absence of descriptive tags (e.g., descriptive tags 108), the training audio sequence 106 is fed directly to the large language model 114. In such embodiments, the large language model 114 can be leveraged as training data generators, known as audio-conditional prefix tuning. In one or more embodiments, audio-conditional prefix tuning involves aligning the representations produced by an audio encoder pre-trained exclusively on audio to the input space of a pre-trained large language model 114 by means of a lightweight mapping network. This enables the large language model 114 to produce music descriptions from audio inputs, with only modest training requirements (both in terms of parameters and data). Once trained, no paired text input is necessary, and the audio alone can be used to directly prompt the large language model 114 to generate a caption.

After generating the training captions 116, the large language model 114 can use the training captions 116 to generate negative training captions 118 through a process that can be referred to as text swapping. In one or more embodiments, the negative training captions 118 are hard negative training captions that are closely aligned to positive training captions (e.g., training captions 116). For example, a training caption 116 may state, “rock music with heavy drums and electric piano,” while a negative training caption 118 may state, “rock music with heavy drums and electric guitar.” In this example, the two captions only differ in the last instrument (e.g., electric guitar instead of electric piano). In such embodiments, generating the negative training captions 118 addresses situations with contrastive learning when one modality is natural language text, where a model may still ignore parts of the text when matching to the other modality (e.g., audio).

In one or more embodiments, the large language model 114 generates the negative training captions 118 by applying perturbations to the previously generated training captions 116, such as randomly swapping a subset of the words. For example, given a training caption 116, the large language model 114 can use a keyword search to find any genre, mood, or instrument nouns, and then change one of them to a randomly selected alternative noun out of a predefined dictionary of terms for each category (e.g., genre, mood, and instruments). Because this change is performed randomly, there is still a chance that the perturbated caption would still correctly describe the track (e.g., consider if the audio sequence described in the example above included both electric piano and electric guitar). However, over a large sample of hard negative training captions, the majority will have a high probability of being actual negative captions.

The training captions 116 and the negative training captions 118 can be combined with the training audio sequence 106 to generate output training dataset 120, at numeral 7. By generating the plurality of training captions 116 and negative training captions 118 for the training audio sequence 106, the output training dataset 120 is a more diverse training dataset. For example, by creating the negative training captions 118 (e.g., hard negatives), the output training dataset 120 can include examples of what not to match (e.g., between descriptive tags and captions), in addition to examples of what to match. This can better train a model by encouraging the model to factor in every word in a given natural language text query and reduce the chances of the model mapping the given natural language text query to audio sequences that matches some of the given natural language text query but not all of it.

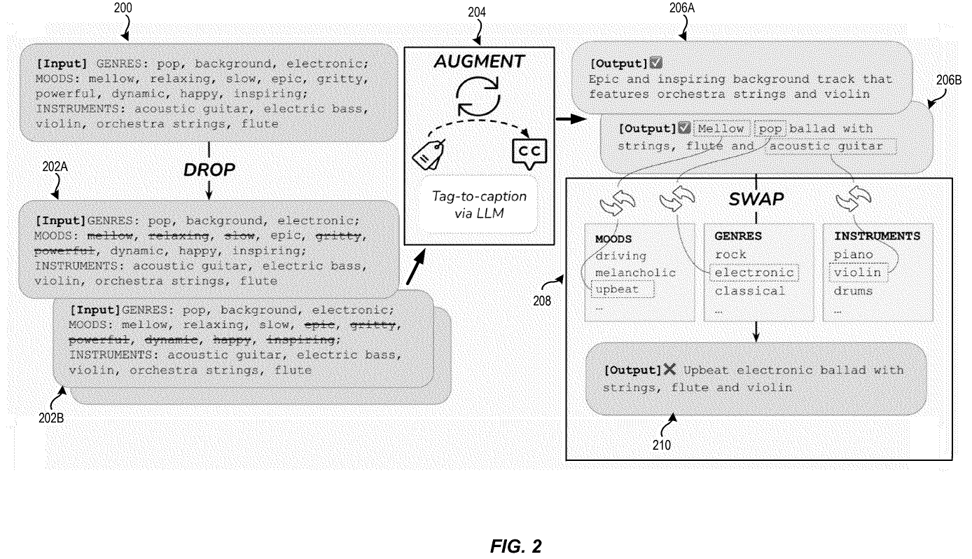

FIG. 2 illustrates exemplary training captions and negative training captions generated by a music-text encoding system in accordance with one or more embodiments. In FIG. 2, a set of descriptive tags 200 associated with a training audio sequence can be obtained by a music-text encoding system (e.g., music-text encoding system 100). The set of descriptive tags 200 can be human-derived or human-written and provided to the music-text encoding system 100. In other embodiments, the set of descriptive tags 200 can be automatically generated from the training audio sequence using a machine learning model trained on music tagging (e.g., by a machine learning model in the music-text encoding system 100 or a machine learning model external to the music-text encoding system 100). In other embodiments, the set of descriptive tags 108 can be a combination of human-derived and machine learning model-derived tags.

In the example in FIG. 2, the set of descriptive tags 200 includes multiple descriptive tags for different categories (e.g., genres, mood, and instruments). In one or more other embodiments, the set of descriptive tags 200 can include descriptive tags for different, or additional, categories. Using the set of descriptive tags 200, a tag selection module (e.g., tag selection module 110) can generate multiple descriptive tag subsets. In one or more embodiments, the tag selection module can randomly select one or more descriptive tags from the set of descriptive tags 200 to “drop,” or otherwise remove or ignore, to form each descriptive tag subset. For example, descriptive tag subset 202A is formed by dropping out or removing multiple descriptive tags in the mood category: “mellow,” “relaxing,” “slow,” “gritty,” and “powerful.” Similarly, descriptive tag subset 202B is formed by dropping out or removing multiple descriptive tags in the mood category: “epic,” “gritty,” “powerful,” “dynamic,” “happy,” and “inspiring.” Additional descriptive tag subsets can be formed by dropping out or removing different descriptive tags.

Descriptive tag subset 202A and descriptive tag subset 202B can then be passed to a large language model to perform an augmentation process 204. In one or more embodiments, in the augmentation process 204, the large language model generates a text caption (e.g., a natural language sentence) that describes the training audio sequence using the descriptive tags in the descriptive tag subsets. Continuing the example, the large language model generates training caption 206A from descriptive tag subset 202A and training caption 206B from descriptive tag subset 202B. In the example, training caption 206A describes the training audio sequence as “epic and inspiring,” while training caption 206A describes the training audio sequence as “mellow.” Both training captions are describing the same training audio sequence, but because different descriptive tags were dropped out from the corresponding descriptive tag subset, they describe different aspects of the training audio sequence.

In one or more embodiments, the large language model can perform a swapping process 208 to generate negative training captions by modifying, or swapping, elements (e.g., words, terms, etc.) in the generated training captions. For example, the elements “mellow,” “pop,” and “acoustic guitar” are selected for swapping with incorrect or inaccurate elements. In one or more embodiments, the elements selected for swapping can be replaced from a menu of options within a same category. In the example in FIG. 2, in the mood category, “mellow” is swapped with “upbeat,” in the genre category, “pop” is swapped with “electronic,” and in the instrument category, “acoustic guitar” is swapped with “violin.” The result of the swapping process 208 is negative training caption 210, where training caption 206B has been modified to “Upbeat electronic ballad with strings, flute and violin.” Negative training caption 210 is a natural language text description that uses multiple correct descriptive tags from descriptive tag subset 202B, but also multiple incorrect or inaccurate descriptive tags that were no in descriptive tag subset 202B. Because negative training caption 210 includes both correct and incorrect description of the training audio sequence, it can be referred to as a hard negative caption, as it closely resembles an accurate training caption (e.g., training caption 206B). The swapping process 208 can be performed one or more times on the training captions generated by the large language model to create a negative training caption dataset. In one or more embodiments, the negative training captions can be used to provide a model being trained with more examples of what not to match, in this way “encouraging” it to factor in every word in the query text, while reducing the chances of the model mapping the query text to music that matches some of the query text but not all of it.

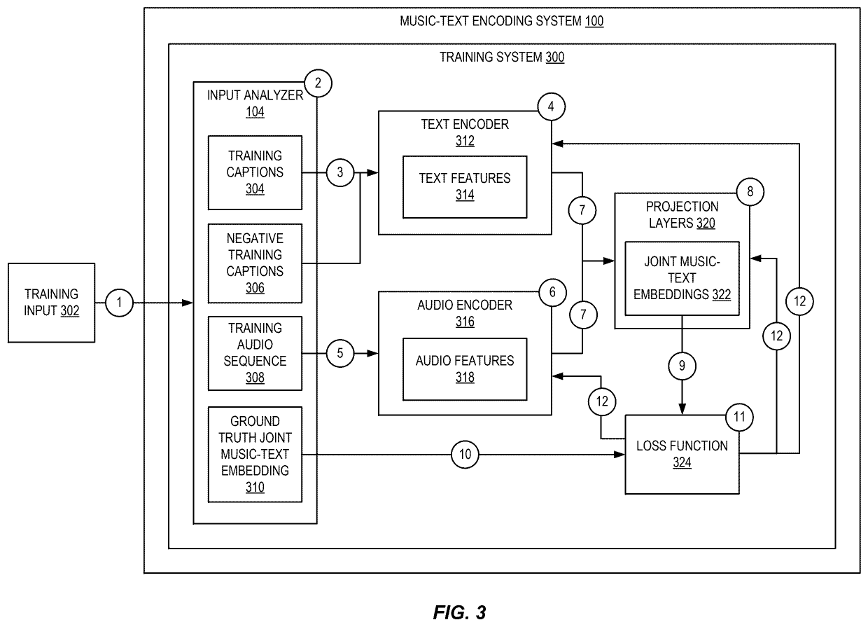

FIG. 3 illustrates a diagram of a process of training a music-text encoding system to encode music audio and natural language text into a shared embedding space in accordance with one or more embodiments. As illustrated in FIG. 3, a music-text encoding system includes a training system 300. In one or more embodiments, the training system 300 includes a text encoder 312, an audio encoder 316, and projection layers 320. In one or more embodiments, the training system 300 is configured to train the text encoder 312, the audio encoder 316, and the projection layers 320 into a model that can be used for music searching and/or music generation based on a natural language text prompt. In some embodiments, the training system 300 is a part of a music-text encoding system 100. In other embodiments, the training system 300 can be a standalone system, or part of another system, and deployed to the music-text encoding system 100. For example, the training system 300 may be implemented as a separate system implemented on electronic devices separate from the electronic devices implementing music-text encoding system 100. As shown in FIG. 3, the training system 300 receives a training input 302, at numeral 1. For example, the music-text encoding system 100 receives the training input 302 from a user via a computing device or from a memory or storage location.

The music-text encoding system 100 includes an input analyzer 104 that receives the training input 302. In some embodiments, the input analyzer 104 is configured to extract the training captions 304, negative training captions 306, training audio sequence 308, and ground truth joint music-text embedding 310 from the training input 302, at numeral 2. In one or more embodiments, the training captions 304 and the negative training captions 306 associated with the training audio sequence 308 may be obtained as described with respect to FIGS. 1 and 2.

The input analyzer 104 then sends the training captions 304 and the negative training captions 306 associated with the training audio sequence 308 to text encoder 312, as shown at numeral 3. In one or more embodiments, the text encoder 312 is trained to generate text features 314 for each of the training captions 304 and negative training captions 306, at numeral 4. In one or more embodiments, each of text features 314 are feature vector representations of a corresponding training caption 304 or negative training caption 306.

In one or more embodiments, the text encoder 312 is a multilingual text encoder. In some embodiments, the multilingual text encoder is a Multilingual Text-to-Text Transfer Transformer (mT5). In such embodiments, the text encoder 312 is capable of encoding text input (e.g., the training captions 304 and the negative training captions 306) from different languages, such that the embeddings of the same text input in different languages are close together in the learned embedding space. In one or more embodiments, the multilingual text encoder supports over one hundred languages for music-text applications, without requiring training data in languages other than English and without requiring any intermediate translation steps.

The input analyzer 104, serially or in parallel, sends the training audio sequence 308 to audio encoder 316, as shown at numeral 5. In one or more embodiments, the audio encoder 316 is trained to generate audio features 318 for the training audio sequence 308, at numeral 6. In one or more embodiments, the audio features 318 are feature vector representations of a corresponding training audio sequence 308.

In one or more embodiments, the text features 314 and audio features 318 are sent to projection layers 320 by the text encoder 312 and the audio encoder 316, respectively, at numeral 7. In one or more embodiments, the projection layers 320 map the text features 314 and audio features 318 to joint music-text embeddings 322, at numeral 8. For example, the text features 314 for each training caption 304 and negative training caption 306 are separately mapped to a joint music-text embeddings of the joint music-text embeddings 322. In one or more embodiments, the projection layers 320 include an audio projection layer for mapping the audio features 318 to a joint music-text embedding space and a text projection layer for mapping the text features 314 to the same joint music-text embedding space. In one or more embodiments, the projection layers project the high-dimensional data from the audio and text modalities onto a lower-dimensional joint representation space whose structure encodes semantic similarity. In one or more embodiments, the projection layers 320 are two-head, two-layer transformers. In other embodiments, the projection layers can be a multilayer perceptron (MLP), or another type of neural network layer.

The joint music-text embeddings 322 are then passed to a loss function 324, as shown at numeral 9. The ground truth joint music-text embedding 310 is also passed to the loss function 324, as shown at numeral 10. Using the joint music-text embeddings 322 and the ground truth joint music-text embedding 310, the loss function 324 can calculate a loss, at numeral 11. In one or more embodiments, the loss function 324 computes a contrastive loss, such as an InfoNCE loss, using cosine similarity between the L2-normalized projection embeddings from the audio and text branch as a scoring function and a temperature parameter of 0.03. In one or more embodiments, the calculated loss is used to optimize the model parameters to encode semantically related music and text inputs within the same neighborhood of the joint music-text embedding space, while pushing apart unrelated items.

The calculated loss can then be backpropagated to train the weights of the text encoder 312, the audio encoder 316, and the projection layers 320, as shown at numeral 13. In embodiments, backpropagating the loss teaches the text encoder 312, the audio encoder 316, and the projection layers 320 to produce embeddings that more accurately encode the description of audio to allow for natural language text queries.

In one or more embodiments, once trained, the model can be used for music searching. Given a collection of music, each music track can be passed through the audio encoder network to produce audio features (e.g., an audio embedding vector representation) of the music audio that exists in the joint music-text embedding space learned by the model. This processing only needs to be run once for the music collection, after which the embeddings are stored in a database for querying. Then, in response to receiving a user's natural language text query, the natural language text query is passed through the text encoder network of the model to produce text features (e.g., a text embedding vector representation) that also exists in the joint music-text embedding space learned by the model. In one or more embodiments, the text embedding can then be compared to the audio embeddings in the database, ranked based on their similarity to the text embedding, and displayed to the user based on this ranking from most similar to least similar. The similarity score can be computed, for example, as the cosine distance between the text embedding vectors and audio embedding vectors. In one or more embodiments, for scalability, the audio embedding vectors can also be stored in a database that supports an efficient nearest neighbors search, so that the natural language text query does not need to be compared to every music track in the collection.

In one or more embodiments, as the search can be executed by comparing embedding vectors in a joint music-text embedding space, the model can also be used to search for music given another music recording as the query rather than a text query. For example, instead of receiving text as the input, the model receives a music track that is representative of the music the user is searching for. In such embodiments, the input music track is converted to a query audio embedding using the audio encoder, and that embedding is used as described above with respect to searching the database for matching music tracks using a text embedding.

In one or more embodiments, once trained, the model can be used for music generation. In some embodiments, text-to-music generation involves encoding a natural language text query and using the encoded natural language text query to drive a generator. In such embodiments, the text encoder of the model can be used to generate the text embedding, which is then provided to a generator neural network that implements music generation, e.g., via diffusion or language modelling. The model can also be used for music-to-music generation (e.g., to drive a music generator using another audio track instead of a natural language text query). Thus, the model can generate music that sounds similar to an input audio track.

In one or more embodiments, large collections of unlabeled music can be leveraged for training the generator. For example, during training, music tracks can be passed through the audio encoder to produce a query vector that is a proxy for a natural language text description of the music tracks. The generator can then be trained as it would be music-text pair. At inference time, the model can accept both text descriptions and music audio as the input query. Thus, once the music-text encoder is trained, a music generation model can be trained (e.g., using diffusion or LLMs) without requiring a large dataset of annotated music data, i.e., without requiring music audio with corresponding textual descriptions.

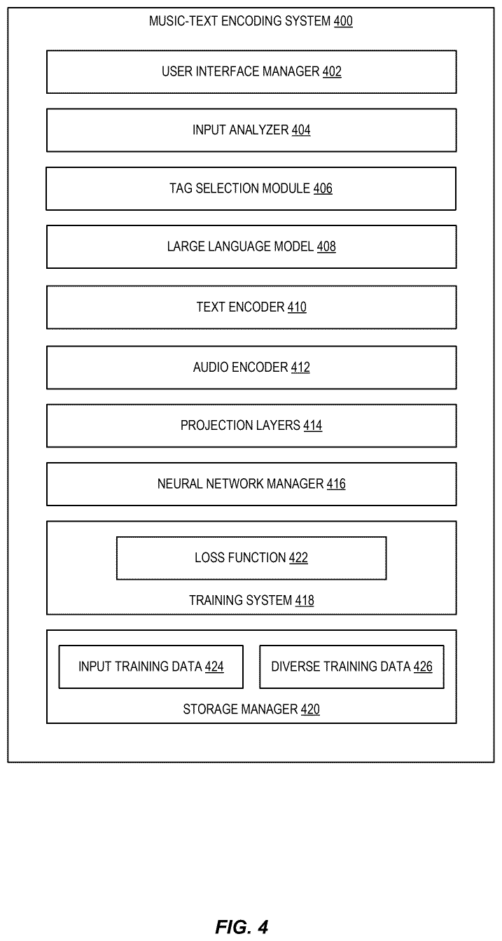

FIG. 4 illustrates a schematic diagram of a music-text encoding system (e.g., “music-text encoding system” described above) in accordance with one or more embodiments. As shown, the music-text encoding system 400 may include, but is not limited to, a user interface manager 402, an input analyzer 404, a tag selection module 406, a large language model 408, a text encoder 410, an audio encoder 412, projection layers 414, a neural network manager 416, a training system 418, and a storage manager 420. The storage manager 420 includes input training data 424 and diverse training data 426.

As illustrated in FIG. 4, the music-text encoding system 400 includes a user interface manager 402. For example, the user interface manager 402 allows users to provide input data to the music-text encoding system 400. In some embodiments, the user interface manager 402 provides a user interface through which the user can upload initial training datasets for generating diverse training datasets or diverse training datasets for training one or more models, as discussed above. Alternatively, or additionally, the user interface may enable the user to download one or more training datasets from a local or remote storage location (e.g., by providing an address (e.g., a URL or other endpoint) associated with a data source).

As further illustrated in FIG. 4, the music-text encoding system 400 also includes an input analyzer 404. The input analyzer 404 analyzes an input received by the music-text encoding system 400 to identify training audio sequences, descriptive tags, training captions, negative training captions, and ground truth joint music-text embeddings.

As further illustrated in FIG. 4, the music-text encoding system 400 also includes a tag selection module 406. The tag selection module 406 is configured to randomly select a subset of the set of descriptive tags describing an audio sequence. The descriptive tags can describe aspects of the audio sequence in multiple categories (e.g., genre, mood, instrumentation, etc.). The tag selection module 406 can select a plurality of different subsets of descriptive tags that can be processed by the large language model 408.

As further illustrated in FIG. 4, the music-text encoding system 400 also includes large language model 408. In one or more embodiments, the large language model 408 is a multimodal large language model, or a similar neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the large language model 408 generates training captions and negative training captions using the plurality of subsets of descriptive tags generated by the tag selection module 406. In one or more embodiments, the large language model 408 is trained to convert each of plurality of subsets of descriptive tags into a separate training caption describing the music audio in the audio sequence. For example, each of the training captions can be a natural language sentence using the descriptive tags in a corresponding descriptive tag subset. In one or more embodiments, the large language model 408 uses a prompt-analogies technique where the prompt includes a small number of example pairs, where each pair includes: (a) a set of descriptive tags and (b) a human-written caption describing the same music track as the descriptive tags. These “analogies,” or examples of inputs (e.g., tags) paired with desired outputs (e.g., captions), guide the large language model 408 in how to leverage going from descriptive tags to a caption.

As further illustrated in FIG. 4, the music-text encoding system 400 also includes text encoder 410. In one or more embodiments, the text encoder 410 generates text features, or a feature vector representation, of text input (e.g., captions describing audio). In one or more embodiments, the text features are n-dimensional vectors of numerical features that represent a corresponding text input. The text encoder 410 can be the Contrastive Language-Image Pre-Training (CLIP) model, a Robustly Optimized BERT Pretraining Approach (RoBERTa) Large model, T5 XXL, or other similar text encoders. In one or more embodiments, the text encoder 410 is a multilingual text encoder (e.g., mT5 XXL) capable of encoding text input from different languages, such that the embeddings of the same text input in different languages are close together in the learned embedding space.

As further illustrated in FIG. 4, the music-text encoding system 400 also includes audio encoder 412. In one or more embodiments, the audio encoder 412 generates audio features, or a feature vector representation, of audio sequences (e.g., music audio). In one or more embodiments, the audio features are n-dimensional vectors of numerical features that represent a corresponding audio sequence. The audio encoder 412 can be a Hierarchical Token-Semantic Audio Transformer (HTS-AT) audio encoder architecture, a Contrastive Language-Audio Pretraining (CLAP) audio encoder, an Acoustic Music Understanding (MERT) audio encoder, or other similar audio encoders.

As further illustrated in FIG. 4, the music-text encoding system 400 also includes projection layers 414. In one or more embodiments, the projection layers 414 include an audio projection layer for mapping audio features to a joint music-text embedding space and a text projection layer for mapping text features to the same joint music-text embedding space. In one or more embodiments, the projection layers 414 are two-head, two-layer transformers. In other embodiments, the projection layers can be a multilayer perceptron (MLP), or another type of neural network layer.

As illustrated in FIG. 4, the music-text encoding system 400 also includes a neural network manager 416. Neural network manager 416 may host a plurality of neural networks or other machine learning models, such as text encoder 410, audio encoder 412, and projection layers 414. The neural network manager 416 may include an execution environment, libraries, and/or any other data needed to execute the machine learning models. In some embodiments, the neural network manager 416 may be associated with dedicated software and/or hardware resources to execute the machine learning models. Although depicted in FIG. 4 as being hosted by a single neural network manager 416 in various embodiments the neural networks may be hosted in multiple neural network managers and/or as part of different components.

As illustrated in FIG. 4 the music-text encoding system 400 also includes training system 418. The training system 418 can teach, guide, tune, and/or train one or more neural networks using a loss function 422. In particular, the training system 418 can train a neural network (e.g., text encoder 410, audio encoder 412, and projection layers 414) based on a plurality of training data. More specifically, the training system 418 can access, identify, generate, create, and/or determine training input and utilize the training input to train and fine-tune a neural network.

As illustrated in FIG. 4, the music-text encoding system 400 also includes the storage manager 420. The storage manager 420 maintains data for the music-text encoding system 400. The storage manager 420 can maintain data of any type, size, or kind as necessary to perform the functions of the music-text encoding system 400. The storage manager 420, as shown in FIG. 4, includes input training data 424 and diverse training data 426. In particular, the input training data 424 may include training audio sequences and corresponding descriptive tags describing the training audio sequences. The music-text encoding system 400 can use the training audio sequences and corresponding descriptive tags to generate diverse training data 426. In particular, in one or more embodiments, the diverse training data 426 includes a plurality of natural language training captions and plurality of natural language negative training captions generated by the music-text encoding system 400. Once generated, the diverse training data 426 can be used to train one or more neural networks (e.g., text encoder 410, audio encoder 412, and projection layers 414) for efficient music-text representation learning.

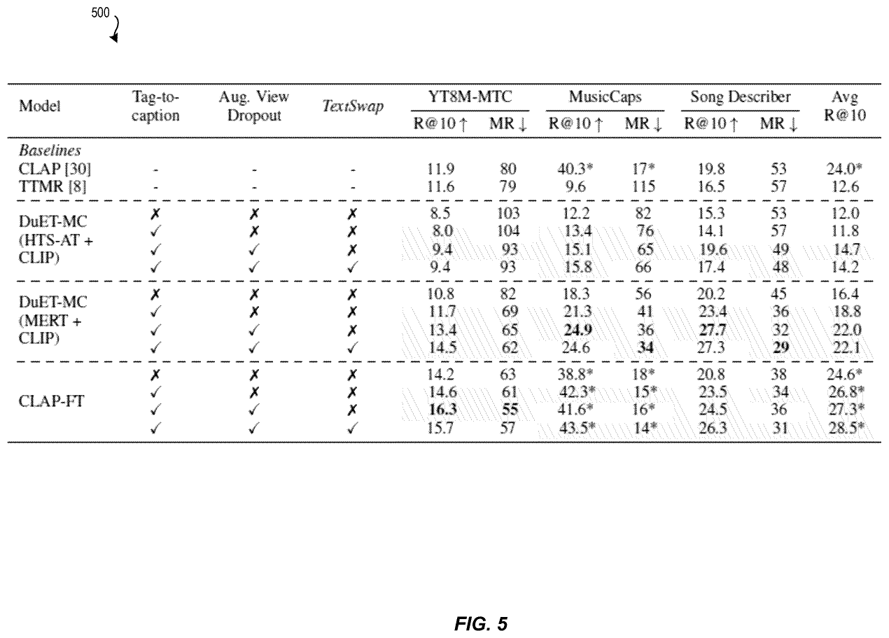

FIG. 5 illustrates a table 500 of experimental results of training models with the diverse training dataset in accordance with one or more embodiments. The experimental results examine the effect of three components in an augmentation pipeline: tag-to-caption augmentation, augmented view dropout (e.g., generating captions using subsets of the descriptive tags), and text swapping (e.g., generating hard negative training captions by swapping elements/keywords). Two scenarios are evaluted: one where the contributions of the argumentations are measured in two variants of a Dual-Encoder Text-Music Contrastive (DuET-MC) framework (e.g., as illustrated in FIG. 3), each with different degrees of audio pre-training and finetuning and locked text encoders, and one computational requirements are relaxed and explore whether the effect of using the argumentations to fintetune a general purpose audio-text embedding model (e.g., CLAP), with limited paired music data.

The table 500 compares the augmentation pipeline with two audio-text contrastive basslines: CLAP and Text-to-Music Retrieval (TTMR), trained on general-purpose audio and music, respectively. The table 500 displays three different settings to which the augmentation pipeline is applied: (1) training the audio encoder from scratch (shown in the HTS-AT +CLIP-T configuration), (2) training only 1% of the parameters in a locked audio-text encoder (MERT+CLIP), and (3) fine-tuning the full model on music, following general audio-text pre-training (CLAP-FT). From this, the results show that while the version of DuET-MC trained only on tags exhibits, at best, comparable performance to the baselines, the addition of each component in the augmentation pipeline lifts performance across all model configurations, pre-training regimes and finetuning strategies for median rank (MR) and recall at 10 (R@10 ) retrieval metrics. The MR retrieval value indicates the median rank of the correct music track, computed over the text queries in the dataset, which a lower value indicating better performance. The R@10 retrieval value indicates the percentage of text queries for which the correct music track is included in the top 10 retrieved tracks, which a higher value indicating better performance. Among these, tag-to-caption and augmented view dropout emerge as the most influential, while the benefits of text swapping are more prominent for model configurations where encoders have higher levels of pre-training. In one or more embodiments, this may indicate a need to increase the complexity of negative training captions later in training.

The experimental results further indicate that the augmentation pipeline provides a data-efficient strategy to improve music-text modelling under a variety of model configurations, at no additional computational cost. Importantly, this trend generalizes across evaluation datasets, suggesting that it is beneficial to model robustness, and demonstrates that the lack of large-scale paired data in the music domain can be alleviated through augmentation-based techniques which enhance data quality instead of quantity. Finally, comparing retrieval scores of different family of models (TTMR, CLAP and DuET-424 MC), shows consistent differences between datasets, with CLAP-based models invariably showing a significant jump in performance on the MusicCaps dataset compared to the YouTube 8 Million Music Text Clips Dataset (YT8M-MTC) and the Song Describer Dataset (SDD).

Each of the components 402-420 of the music-text encoding system 400 and their corresponding elements (as shown in FIG. 4) may be in communication with one another using any suitable communication technologies. It will be recognized that although components 402-420 and their corresponding elements are shown to be separate in FIG. 4, any of components 402-420 and their corresponding elements may be combined into fewer components, such as into a single facility or module, divided into more components, or configured into different components as may serve a particular embodiment.

The components 402-420 and their corresponding elements can comprise software, hardware, or both. For example, the components 402-420 and their corresponding elements can comprise one or more instructions stored on a computer-readable storage medium and executable by processors of one or more computing devices. When executed by the one or more processors, the computer-executable instructions of the music-text encoding system 400 can cause a client device and/or a server device to perform the methods described herein. Alternatively, the components 402-420 and their corresponding elements can comprise hardware, such as a special purpose processing device to perform a certain function or group of functions. Additionally, the components 402-420 and their corresponding elements can comprise a combination of computer-executable instructions and hardware.

Furthermore, the components 402-420 of the music-text encoding system 400 may, for example, be implemented as one or more stand-alone applications, as one or more modules of an application, as one or more plug-ins, as one or more library functions or functions that may be called by other applications, and/or as a cloud-computing model. Thus, the components 402-420 of the music-text encoding system 400 may be implemented as a stand-alone application, such as a desktop or mobile application. Furthermore, the components 402-420 of the music-text encoding system 400 may be implemented as one or more web-based applications hosted on a remote server. Alternatively, or additionally, the components of the music-text encoding system 400 may be implemented in a suite of mobile device applications or “apps.”

As shown, the music-text encoding system 400 can be implemented as a single system. In other embodiments, the music-text encoding system 400 can be implemented in whole, or in part, across multiple systems. For example, one or more functions of the music-text encoding system 400 can be performed by one or more servers, and one or more functions of the music-text encoding system 400 can be performed by one or more client devices. The one or more servers and/or one or more client devices may generate, store, receive, and transmit any type of data used by the music-text encoding system 400, as described herein.

In one implementation, the one or more client devices can include or implement at least a portion of the music-text encoding system 400. In other implementations, the one or more servers can include or implement at least a portion of the music-text encoding system 400. For instance, the music-text encoding system 400 can include an application running on the one or more servers or a portion of the music-text encoding system 400 can be downloaded from the one or more servers. Additionally or alternatively, the music-text encoding system 400 can include a web hosting application that allows the client device(s) to interact with content hosted at the one or more server(s). For example, upon a client device accessing a webpage or other web application hosted at the one or more servers, in one or more embodiments, the one or more servers can provide access to an initial training input that includes training audio sequences and descriptive tags describing the training audio sequences stored at the one or more servers. Moreover, the client device can receive a request (i.e., via user input) to generate diverse training data from the initial training input. Upon receiving the request, the one or more servers can automatically perform the methods and processes described above. The one or more servers can generate diverse training data from the initial training input, which can be used to train music-text encoders.

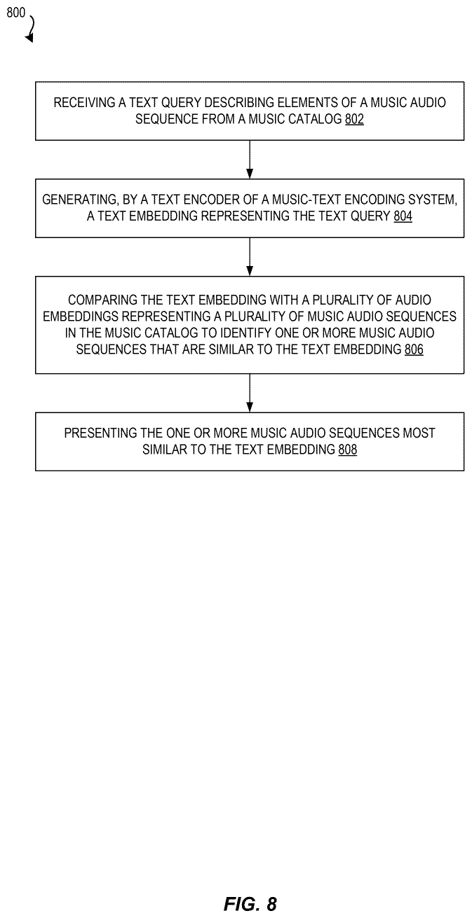

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 8. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 8.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 8.

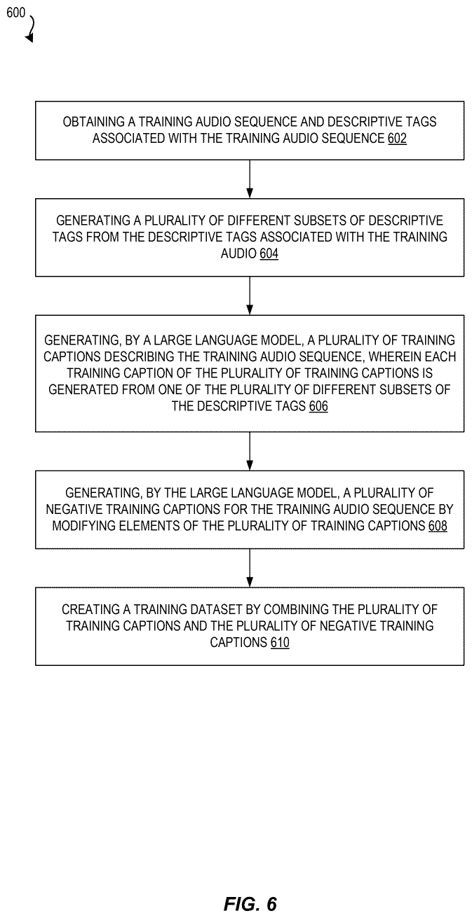

FIGS. 1-5, the corresponding text, and the examples, provide a number of different systems and devices that generate diverse training data for music-text representation learning and training models using the diverse training data. In addition to the foregoing, embodiments can also be described in terms of flowcharts comprising acts and steps in a method for accomplishing a particular result. For example, FIGS. 6-8 illustrate flowcharts of exemplary methods in accordance with one or more embodiments. The methods described in relation to FIGS. 6-8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart of a series of acts in a method of generating a diverse training dataset for training a music-text encoding system in accordance with one or more embodiments. In one or more embodiments, the method 600 is performed in a digital medium environment that includes the music-text encoding system 400. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of obtaining a training audio sequence and descriptive tags associated with the training audio sequence. In one or more embodiments, the training audio sequence and descriptive tags are provided to the music-text encoding system. In one or more embodiments, the music-text encoding system receives the input from a user (e.g., via a computing device). In one or more embodiments, the user may select or provide the input in an application, or the user may submit the input to a web service or an application configured to receive inputs.

In one or more embodiments, the descriptive tags describe aspects of an associated training audio sequence in a plurality of categories, including genre, mood, and instrumentation. In some embodiments, the descriptive tags are human-derived. In other embodiments, the input can include the training audio sequence and the descriptive tags can be generated by the music-text encoding system or by another system.

As illustrated in FIG. 6, the method 600 includes an act 604 of generating a plurality of different subsets of descriptive tags from the descriptive tags associated with the training audio. In one or more embodiments, the descriptive tags are sent to a tag selection module. In one or more embodiments, the tag selection module is configured to generate a plurality of descriptive tag subsets from the descriptive tags. In some embodiments, the tag selection module randomly selects a number of descriptive tags as the subset of descriptive tags. In such embodiments, the number of randomly selected tags can be user-defined. In some embodiments, the tag selection module can select at least one descriptive tag from each of the plurality of categories. In one or more embodiments, the tag selection module can repeat the process multiple times to obtain the plurality of descriptive tag subsets, where each includes a different subset of the descriptive tags.

As illustrated in FIG. 6, the method 600 includes an act 606 of generating, by a large language model, a plurality of training captions describing the training audio sequence, wherein each training caption of the plurality of training captions is generated from one of the plurality of different subsets of the descriptive tags. In one or more embodiments, the plurality of descriptive tag subsets are sent to a large language model. In one or more embodiments, the large language model is a multimodal large language model, or a similar neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the large language model is trained to convert each of the plurality of descriptive tag subsets into a separate training caption describing the music audio in the training audio sequence. For example, each of the training captions can be a natural language sentence using the descriptive tags in a corresponding descriptive tag subset. In one or more embodiments, the large language model uses a prompt-analogies technique where the prompt includes a small number of example pairs, where each pair includes: (a) a set of descriptive tags and (b) a human-written caption describing the same music track as the descriptive tags. These “analogies,” or examples of inputs (e.g., tags) paired with desired outputs (e.g., captions), guide the large language model in how to leverage going from descriptive tags to a caption.

As illustrated in FIG. 6, the method 600 includes an act 608 of generating, by the large language model, a plurality of negative training captions for the training audio sequence by modifying elements of the plurality of training captions. In one or more embodiments, after generating the training captions, the large language model can use the training captions to generate negative training captions. In one or more embodiments, the large language model generates the negative training captions by applying perturbations to the previously generated training captions, such as randomly swapping a subset of the words. For example, given a training caption, the large language model can use a keyword search to find any genre, mood, or instrument nouns, and then replace one of them with a randomly selected alternative noun out of a predefined dictionary of terms for a corresponding category (e.g., genre, mood, and instruments).

In one or more embodiments, the negative training captions are also referred to as hard negative training captions because they are closely aligned to positive training captions (e.g., training captions). In such embodiments, generating the negative training captions addresses situations with contrastive learning when one modality is natural language text, where a model may still ignore parts of the text when matching to the other modality (e.g., audio).

As illustrated in FIG. 6, the method 600 includes an act 610 of creating a training dataset by combining the plurality of training captions and the plurality of negative training captions. In one or more embodiments, the plurality of training captions and the plurality of negative training captions are aggregated into a training set that includes more diversity than the original input training dataset. By generating one hard negative training caption for every training caption, the size of the training dataset is doubled. Generating multiple hard negative training captions for each training caption further increases the size of the training dataset. Once generated, the training dataset can be used to train a music-text encoding system.

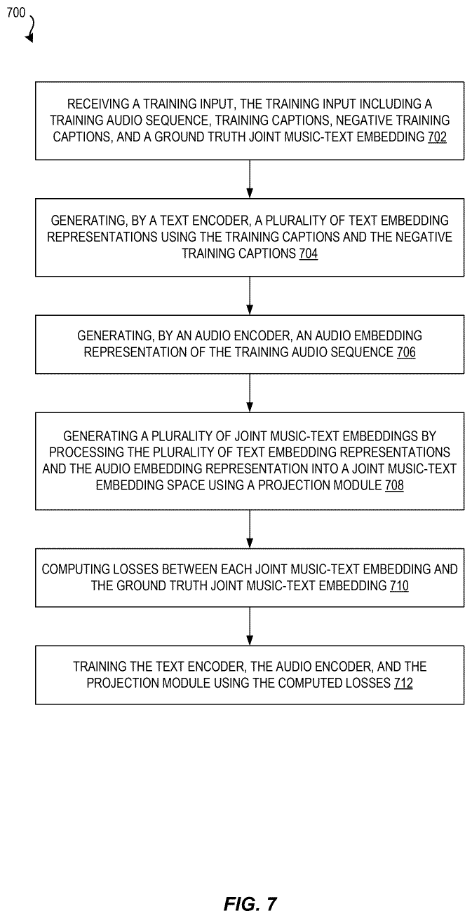

FIG. 7 illustrates a flowchart of a series of acts in a method training a music-text encoding system using a diverse training dataset in accordance with one or more embodiments. In one or more embodiments, the method 700 is performed in a digital medium environment that includes the music-text encoding system 400. The method 700 is intended to be illustrative of one or more methods in accordance with the present disclosure and is not intended to limit potential embodiments. Alternative embodiments can include additional, fewer, or different steps than those articulated in FIG. 7.

As illustrated in FIG. 7, the method 700 includes an act 702 of receiving a training input, the training input including a training audio sequence, training captions, negative training captions, and a ground truth joint music-text embedding. In one or more embodiments, a music-text encoding system (e.g., music-text encoding system 100) receives the training input in a single input or in multiple inputs. The training input can be part of a batch that includes multiple training audio sequences and corresponding training captions, negative training captions, and ground truth joint music-text embedding that can be fed to a training manager in parallel or in series. In one or more embodiments, the training captions and negative training captions in the training input can be generated in a process as described with respect to FIGS. 1 and 2.

As illustrated in FIG. 7, the method 700 includes an act 704 of generating, by a text encoder, a plurality of text embedding representations using the training captions and the negative training captions. In one or more embodiments, the text encoder generates text features for each of the training captions and negative training captions. In one or more embodiments, each of text features are feature vector representations of a corresponding training caption or negative training caption.

In one or more embodiments, the text encoder is a multilingual text encoder. In some embodiments, the multilingual text encoder is a Multilingual Text-to-Text Transfer Transformer (mT5). In such embodiments, the text encoder is capable of encoding text input (e.g., the training captions and the negative training captions) from different languages, such that the embeddings of the same text input in different languages are close together in the learned embedding space.

As illustrated in FIG. 7, the method 700 includes an act 706 of generating, by an audio encoder, an audio embedding representation of the training audio sequence. In one or more embodiments, the audio encoder generates audio features for the training audio sequence. In one or more embodiments, the audio features are feature vector representations of a corresponding training audio sequence.

As illustrated in FIG. 7, the method 700 includes an act 708 of generating a plurality of joint music-text embeddings by processing the plurality of text embedding representations and the audio embedding representation into a joint music-text embedding space using a projection module. In one or more embodiments, the text embedding representations and audio embedding representation are sent to projection layers by the text encoder and the audio encoder, respectively. In one or more embodiments, the projection layers map the text embedding representations and audio embedding representation to joint music-text embeddings. For example, the text embedding representations for each training caption and negative training caption are separately mapped to a joint music-text embedding with the audio embedding representation. In one or more embodiments, the projection layers include an audio projection layer for mapping the audio embedding representation and a text projection layer for mapping the text embedding representations to the same joint music-text embedding space. In one or more embodiments, the projection layers are two-head, two-layer transformers. In other embodiments, the projection layers can be a multilayer perceptron (MLP), or another type of neural network layer.

As illustrated in FIG. 7, the method 700 includes an act 710 of computing losses between each joint music-text embedding and the ground truth joint music-text embedding. In one or more embodiments, using the joint music-text embeddings and the ground truth joint music-text embedding, a loss function computes losses. In one or more embodiments, the loss function is a contrastive loss, such as an InfoNCE loss. The computed loss can then be backpropagated to train the weights of the text encoder, the audio encoder, and the projection layers. In embodiments, backpropagating the loss teaches the text encoder, the audio encoder, and the projection layers to produce embeddings that more accurately encode the description of music to allow for processing of natural language text queries related to music.

As illustrated in FIG. 7, the method 700 includes an act 712 of training the text encoder, the audio encoder, and the projection module using the computed losses. In one or more embodiments, the computed losses are backpropagated to the text encoder, the audio encoder, and the projection module.

FIG. 8 illustrates a flowchart of a series of acts in a method for performing a music search using a music-text encoding system trained using a diverse training dataset in accordance with one or more embodiments. In one or more embodiments, the method 800 is performed in a digital medium environment that includes the music-text encoding system 400. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of receiving a text query describing elements of a music audio sequence from a music catalog. In one or more embodiments, the text query is received by a music searching system that includes a trained music-text encoding system. In such embodiments, the music searching system receives the text query as an input from a user (e.g., via a computing device). In one or more embodiments, the user may select or provide the input in an application, or the user may submit the input to a web service or an application configured to receive inputs. After receiving the text query, the music searching system can direct the text query to the music-text encoding system.

As illustrated in FIG. 8, the method 800 includes an act 804 of generating, by a text encoder of the music-text encoding system, a text embedding representing the text query. In one or more embodiments, the music-text encoding system can be trained to map audio embeddings representing music audio and text embeddings representing text caption into a joint music-text embedding space, in a process as described previously. In one or more embodiments, the text encoder generates the text embedding (e.g., text features) for the text query. In one or more embodiments, the text embedding is a feature vector representation of text query.

As illustrated in FIG. 8, the method 800 includes an act 806 of comparing the text embedding with a plurality of audio embeddings representing a plurality of music audio sequences in the music catalog to identify one or more music audio sequences that are similar to the text embedding. In one or more embodiments, the music audio sequences in the music catalog are passed through the audio encoder of the music-text encoding system to produce audio embeddings (e.g., numerical representations of the music audio that exists in the joint text-music embedding space learned by the music-text encoding system). The audio embeddings are stored in a music catalog database for querying. The text embedding can then be compared to the embeddings of the music audio sequence in the music catalog database. In one or more embodiments, a similarity score for each music audio sequence can be computed as the cosine distance between the text embedding and audio embedding vectors. For scalability, the audio embedding vectors can also be stored in a music catalog database that supports an efficient nearest neighbors search, so that the text query does not need to be compared to every music audio sequences in the music catalog.

As illustrated in FIG. 8, the method 800 includes an act 808 of presenting the one or more music audio sequences most similar to the text embedding. In one or more embodiments, the one or more music audio sequences most similar to the text embedding can be ranked based on their similarity to the text embedding and displayed to the user based on this ranking from most similar to least similar (e.g., the N more similar tracks are presented).

In one or more embodiments, because the music-text encoding system generates and maps embeddings into the joint music-text embedding space, the music searching system that includes the trained music-text encoding system can additionally be used to search for music audio sequences given an input music audio sequence as the query rather than a text query. In such embodiments, a music audio sequence representative of the music audio sequence the user is searching for is provided to the music searching system. An audio encoder of the music-text encoding system generates an audio embedding representing the input music audio sequence, which is then used to query the embeddings in the joint music-text embedding space to identify similar audio sequences (e.g., in a similar manner as described previously with respect to the text query input).

In one or more alternative embodiments, the trained music-text encoding system can be implemented as part of a music generation system. In such embodiments, the encoders of the music-text encoding system can be used in combination with a generator neural network that can implement music generation (e.g., via diffusion or language modeling). For music generation given a text query, because the music-text encoding system was trained specifically for text-music understanding, it can encode the text query in a way that better captures the musical attributes described in the query compared to text encoders that were not trained on music understanding. This can lead to better music generation results in terms of the generated music more closely matching the description provided in the text query. For music generation given a music audio sequence as the input, the music generation system can generate music that sounds similar to an input music audio sequence. Furthermore, it allows for large collections of unlabeled music to be leveraged for training the generator. For example, during training, music audio sequences can be passed through the audio encoder of the music-text encoding system to produce a query vector that is a proxy for a textual description of the music audio sequence, and then the generator can be trained as it would be using a text-music pair. At inference time, the music-text encoding system can accept both text descriptions and music audio sequences as the input query. This means that once the music-text encoding system is trained, a music generation model can be trained (e.g., using diffusion or large language models (LLMs)) without requiring a large dataset of annotated music data (e.g., music audio sequences with corresponding textual descriptions).

In one or more embodiments, the music-text encoding system can be used to evaluate music generation systems. For example, music generated by a music generation system can be passed through the audio encoder of the music-text encoding system and the resulting audio embedding can be compared against the audio embedding of the text or music audio sequence query that was used to drive the generator neural network. In such embodiments, the more similar the audio embeddings are, the more the generated music captures the musical elements described in the text or music audio sequence query. As such, the music-text encoding system can be used to evaluate the overall semantic similarity between a set of text queries and their corresponding generated music, and this result can be used to guide the development and further improvement of the generator neural network.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

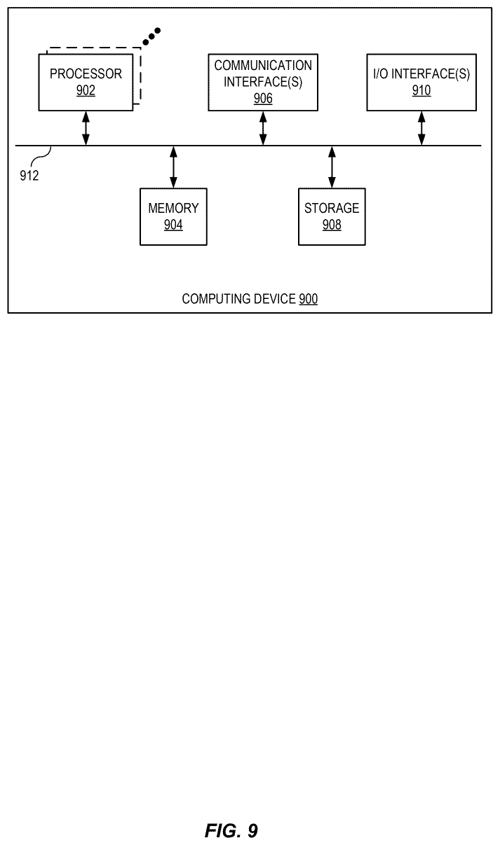

FIG. 9 illustrates, in block diagram form, an exemplary computing device 900 that may be configured to perform one or more of the processes described above. One will appreciate that one or more computing devices such as the computing device 900 may implement the music-text encoding system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a training audio sequence and descriptive tags associated with the training audio sequence;
generating a plurality of different subsets of descriptive tags from the descriptive tags associated with the training audio sequence;
generating, by a large language model, a plurality of training captions describing the training audio sequence, wherein each training caption of the plurality of training captions is generated from one of the plurality of different subsets of the descriptive tags;
generating, by the large language model, a plurality of negative training captions for the training audio sequence by modifying elements of the plurality of training captions; and
creating a training dataset by combining the plurality of training captions and the plurality of negative training captions.

2. The method of claim 1, wherein generating the plurality of different subsets of descriptive tags from the descriptive tags associated with the training audio sequence further comprises:
randomly selecting one or more descriptive tags from the descriptive tags associated with the training audio sequence.

3. The method of claim 1, wherein generating the plurality of training captions describing the training audio sequence further comprises:
for each different subset of the descriptive tags:
generating, by the large language model, a natural language sentence describing the training audio sequence as a training caption of the plurality of training captions.

4. The method of claim 3, wherein generating the plurality of negative training captions for the training audio sequence by modifying elements of the plurality of training captions further comprises:
generating each negative training caption of the plurality of negative training captions by:
randomly selecting one or more terms of one of the plurality of training captions, and
replacing each of the randomly selected one or more terms with an inaccurate term.

5. The method of claim 4, wherein randomly selecting the one or more terms of the one of the plurality of training captions further comprises:
selecting one or more tags from the descriptive tags associated with the training audio sequence for one or more of a plurality of categories, wherein the plurality of categories include genre, mood, and instrumentation.

6. The method of claim 4, wherein replacing each of the randomly selected one or more terms with the inaccurate term further comprises:
selecting the inaccurate term from a dictionary of terms associated with a corresponding category as a randomly selected term of the randomly selected one or more terms.

7. The method of claim 1, wherein the plurality of training captions and the plurality of negative training captions are natural language sentences.

8. The method of claim 1, further comprising:
training a music-text encoding system to generate joint music-text embeddings for audio sequences using the training dataset.

9. A non-transitory computer-readable medium storing executable instructions, which when executed by a processing device, cause the processing device to perform operations comprising:
obtaining a training audio sequence and descriptive tags associated with the training audio sequence;
generating a plurality of different subsets of descriptive tags from the descriptive tags associated with the training audio sequence;
generating, by a large language model, a plurality of training captions describing the training audio sequence, wherein each training caption of the plurality of training captions is generated from one of the plurality of different subsets of the descriptive tags;
generating, by the large language model, a plurality of negative training captions for the training audio sequence by modifying elements of the plurality of training captions; and
creating a training dataset by combining the plurality of training captions and the plurality of negative training captions.

10. The non-transitory computer-readable medium of claim 9, wherein the instructions to generate the plurality of different subsets of descriptive tags from the descriptive tags associated with the training audio sequence further comprise:
randomly selecting one or more descriptive tags from the descriptive tags associated with the training audio sequence.

11. The non-transitory computer-readable medium of claim 9, wherein the instructions to generate the plurality of training captions describing the training audio sequence further comprise:
for each different subset of the descriptive tags:
generating, by the large language model, a natural language sentence describing the training audio sequence as a training caption of the plurality of training captions.

12. The non-transitory computer-readable medium of claim 11, wherein the instructions to generate the plurality of negative training captions for the training audio sequence by modifying elements of the plurality of training captions further comprise:
generating each negative training caption of the plurality of negative training captions by:
randomly selecting one or more terms of one of the plurality of training captions, and
replacing each of the randomly selected one or more terms with an inaccurate term.

13. The non-transitory computer-readable medium of claim 12, wherein the instructions to randomly select the one or more terms of the one of the plurality of training captions further comprise:
selecting one or more tags from the descriptive tags associated with the training audio sequence for one or more of a plurality of categories, wherein the plurality of categories include genre, mood, and instrumentation.

14. A system comprising:
a memory component; and
a processing device coupled to the memory component, the processing device to perform operations comprising:
receiving a text query describing elements of a music audio sequence from a music catalog;
generating, by a text encoder of a music-text encoding system, a text embedding representing the text query;
comparing the text embedding with a plurality of joint music-text embeddings representing a plurality of music audio sequences in the music catalog to identify one or more music audio sequences that are similar to the text embedding; and
presenting the one or more music audio sequences most similar to the text embedding.

15. The system of claim 14, wherein the plurality of joint music-text embeddings representing a plurality of music audio sequences in the music catalog are generated by the music-text encoding system, and wherein the music-text encoding system is trained by:
receiving a training input, the training input including a training audio sequence, training captions, negative training captions, and a ground truth joint music-text embedding;
generating, by a text encoder, a plurality of text embedding representations using the training captions and the negative training captions;
generating, by an audio encoder, an audio embedding representation of the training audio sequence;
generating a plurality of joint music-text embeddings by processing the plurality of text embedding representations and the audio embedding representation into a joint music-text embedding space using a projection module;
computing losses between each joint music-text embedding and the ground truth joint music-text embedding; and
training the text encoder, the audio encoder, and the projection module using the computed losses.

16. The system of claim 15, wherein the training captions are generated by:
generating a plurality of different subsets of descriptive tags from descriptive tags associated with the training audio sequence; and
for each different subset of the plurality of different subsets of descriptive tags, generating, by a large language model, a natural language sentence describing the training audio sequence as a training caption of a plurality of training captions.

17. The system of claim 16, wherein the negative training captions are generated by:
randomly selecting one or more terms of one of the plurality of training captions, and
replacing each of the randomly selected one or more terms with an inaccurate term.

18. The system of claim 17, wherein the operations of randomly selecting the one or more terms of the one of the plurality of training captions further comprise:
selecting one or more tags from the descriptive tags associated with the training audio sequence for one or more of a plurality of categories, wherein the plurality of categories include genre, mood, and instrumentation.

19. The system of claim 17, wherein the operations of replace each of the randomly selected one or more terms with the inaccurate term further comprise:
selecting the inaccurate term from a dictionary of terms associated with a corresponding category as a randomly selected term of the randomly selected one or more terms.

20. The system of claim 15, wherein the training captions and the negative training captions are natural language sentences.
